(19) United States
(12) Patent Application Publication
(10) Pub. No.: US 2016/0344541 A1
(43) Pub. Date: Nov. 24, 2016

(54) PROCESSING DEVICE AND OPERATING METHOD THEREFOR

(71) Applicant: Robert Bosch GmbH, Stuttgart (DE)

(72) Inventors: Paulius Duplys, Markgroeningen (DE); Benjamin Glas, Stuttgart (DE); Hamit Hacioglu, Stuttgart (DE)

(21) Appl. No.: 15/146,732

(22) Filed: May 4, 2016

(30) Foreign Application Priority Data
May 19, 2015 (DE) 102015209120.1

(51) Int. Cl. H04L 9/00; H04L 9/14; H04L 29/06

(52) U.S. Cl. CPC H04L 9/004; H04L 63/1466; H04L 63/1416; H04L 9/14

(57) ABSTRACT

A processing device including a primary processing unit and at least one secondary processing unit, the primary processing unit being designed to subject primary digital input data to a predefinable first data processing, whereby primary digital output data are obtained, the secondary processing unit being designed to subject secondary digital input data to a predefinable second data processing, whereby secondary digital output data are obtained, and the processing device being designed to at least intermittently invert the primary digital input data to obtain the secondary digital input data.

### CROSS REFERENCE

The present application claims the benefit under 35 U.S.C. §119 of German Patent Application No. DE 102015209120.1 filed on May 19, 2015, which is expressly incorporated herein by reference in its entirety.

### BACKGROUND INFORMATION

The present invention relates to a processing device including a primary processing unit and at least one secondary processing unit, the primary processing unit being designed to subject primary digital input data to a predefinable first data processing, whereby primary digital output data are obtained, the secondary processing unit being designed to subject secondary digital input data to a predefinable second data processing, whereby secondary digital output data are obtained. Such processing devices including multiple processing units are also referred to as multi-core processing devices.

The present invention further relates to an operating method for a processing device.

The aforementioned devices or methods are used, among other things, to carry out cryptographic procedures or in general to process security-relevant data, in particular in the field of IT security. The above-described systems and methods, or more precisely their specific implementation as hardware and software, are attackable in a target system, such as a multi-core microcontroller or the like, using so-called side channel attacks (SCAs). In these side channel attacks, one or multiple physical parameters (e.g., power consumption, electromagnetic radiation and the like) of a system to be attacked are detected and analyzed with respect to a correlation with secret data, such as secret keys of cryptographic procedures. An attacker is then able to obtain information therefrom about the secret key and/or the processed algorithms or data.

Another class of attacks against the aforementioned systems and methods is to actively inject faults into the system as a method is being carried out. These attacks are also referred to as fault injection attacks.

### SUMMARY

It is an object of the present invention to improve a processing device and an operating method to the effect that increased security is provided, in particular against side channel attacks and fault injection attacks.

This object may achieved in accordance with the present invention. The processing device is designed to invert the primary digital input data at least intermittently in order to obtain the secondary digital input data. This advantageously causes that at least intermittently inverted primary digital input data are supplied to the predefinable second data processing as secondary digital input data, whereby side channel attacks may be made more difficult. It is also possible to make fault injection attacks more difficult in this way.

In one preferred specific embodiment, it is provided that an operating state, in particular a fault, of the primary processing unit and/or of the secondary processing unit is inferred as a function of the primary digital output data and the secondary digital output data. For example, the processing device may have a comparison and/or evaluation device for this purpose, which compares the primary digital output data and the secondary digital output data to each other, the comparison optionally also being able to be carried out as a function of the properties of the first or second data processing or of the input data. It is thus possible to establish discrepancies or faults in the data processing in at least one processing unit.

According to one specific embodiment, an inverting unit is particularly advantageously assigned to the secondary processing unit, the inverting unit being designed to form the secondary digital input data as a function of the primary digital input data. The inverting unit may be directly integrated into the secondary processing unit, for example, and accordingly carry out the inversion of the suppliable digital input data locally. As an alternative or in addition, the processing device may also have an inverting unit which is situated in particular outside the second processing unit and which derives secondary digital input data from the primary digital input data by way of the inversion.

In a further advantageous specific embodiment, it is provided that a hardware structure of the secondary processing unit is generally identical to a hardware structure of the primary processing unit. For example, the processing device according to the present specific embodiment may thus be designed as a multi-core microcontroller or multi-core processor having multiple generally identically designed cores.

In a further advantageous specific embodiment, it is provided that the first data processing is essentially identical to the second data processing. In particular, the first data processing and the second data processing may include the processing of the same algorithm. In this way, it is advantageously possible that the multiple processing units of the processing device according to the present invention generally carry out the same calculation processes or data processings on the supplied input data. For example, with a generally identical design of the primary and second processing units, and a generally identical design of the first and second data processings, it is possible to carry out redundant data processing by the various processing units, with the special characteristic that, according to the present invention, the secondary processing unit is supplied with at least intermittently inverted data with respect to the primary digital input data supplied to the primary processing unit. In this way, advantageously redundant data processing is created on the one hand, with the option of detecting faults, while at the same time an advantageous increase in security of the processing device against side channel attacks exists, since the at least intermittent inversion of the primary digital input data to obtain the secondary digital input data allows an at least intermittently almost complete compensation of physical parameters of the processing device which are detectable with the aid of the side channel attack, so that a significantly increased complexity is needed for a side channel attack on the system according to the present invention in order to provide the same prospects for success as with conventional multi-core processing devices. In particular, for example a significant equalization of the electrical energy consumption of the entire processing device would thus take place, which reduces the leakage of secret data and thus makes side channel attacks more difficult. Moreover, due to the principle according to the present invention, examinations by the applicant have also shown to yield an improved load distribution among the multiple processing units and an improved electromagnetic compatibility (EMC) behavior (e.g., through at least partial compensation of the emitted electromagnetic fields).

In a further advantageous specific embodiment, it is provided that the primary processing unit and the secondary processing unit are designed to carry out the first data processing and the second data processing generally simultaneously. In this way, the robustness against side channel attacks may be increased further. If the secondary digital input data intended for the secondary processing unit are obtained by an inversion operation in the secondary processing unit from the primary digital input data for the primary processing unit, it is possible, for example, to provide a corresponding time lag in the first data processing of the primary processing unit to ensure that the first and second data processings may be carried out essentially simultaneously.

In a further advantageous embodiment, it is provided that the primary processing unit and the secondary processing unit are designed to carry out at least individual data processing steps of the first data processing and of the second data processing with a non-vanishing time difference with respect to each other, the time difference preferably being randomly or pseudorandomly selected. In a particularly preferred specific embodiment, it is provided that the non-vanishing time difference is randomly or pseudorandomly selected and varies between different steps of the first and second data processings, so that not all consecutive data processing steps have the same non-vanishing time difference between the two processing units or their data processings. Particularly preferably, for example, the non-vanishing time difference or its application to the data processing by the primary or second processing unit may also take place in a pseudorandom or random pattern.

In a further advantageous specific embodiment, it is provided that the processing device is designed to carry out a cryptographic procedure and/or at least a portion thereof, in particular the first and second data processings including at least substeps of one or multiple cryptographic algorithms.

In a further advantageous specific embodiment, it is provided that the primary processing unit and the secondary processing unit are situated on the same semiconductor die and/or connected to the same electrical energy supply. In this way, preferably a further increase in security against side channel attacks is created.

Exemplary specific embodiments of the present invention are described hereafter with reference to the figures.

### BRIEF DESCRIPTION OF THE DRAWINGS

FIG. 1 schematically shows one specific embodiment of a processing device according to the present invention.

FIG. 2 schematically shows a portion of a further specific embodiment.

FIG. 3 schematically shows a simplified flow chart of one specific embodiment of a method according to the present invention.

### DETAILED DESCRIPTION OF EXAMPLE EMBODIMENTS

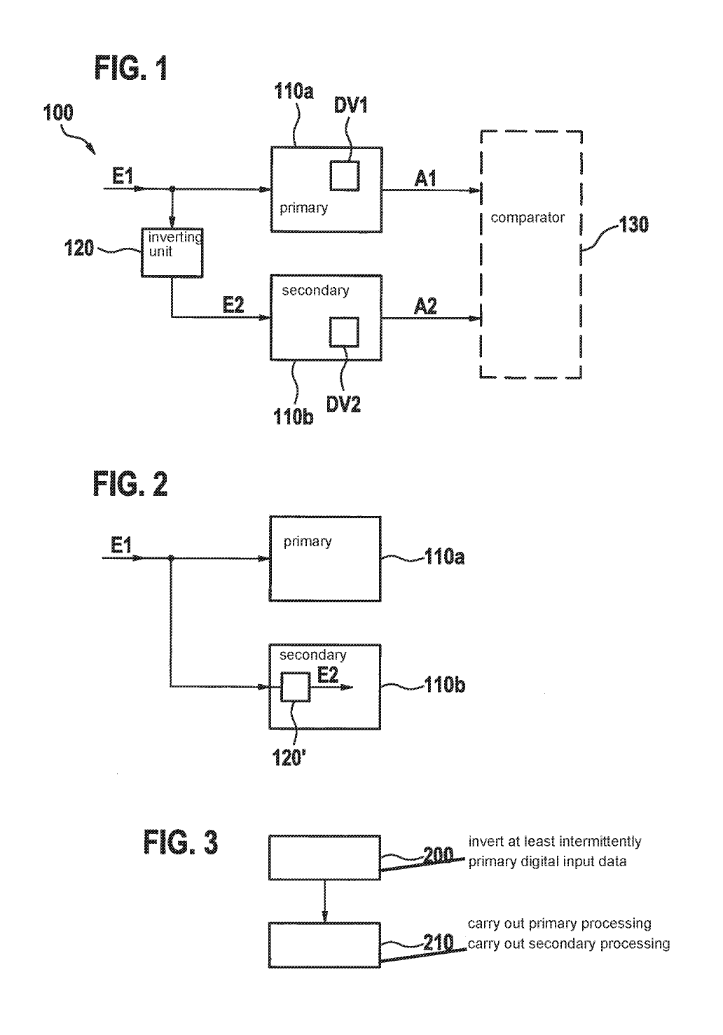

FIG. 1 schematically shows a block diagram of one specific embodiment of a processing device 100 according to the present invention. Processing device 100 in the present example includes a primary processing unit 110a and a secondary processing unit 110b. Primary processing unit 110a is designed to subject primary digital input data E1 to a predefinable first data processing DV1, whereby primary digital output data A1 are obtained. Secondary processing unit 110b is designed to subject secondary digital input data E2 to a predefinable second data processing DV2, whereby secondary digital output data A2 are obtained.

In the present example, data processings DV1, DV2 are symbolically represented as rectangles within the particular processing units 110a, 110b. It shall be understood that the data processings DV1, DV2 may represent processing rules or algorithms or other rules for the data processing of input data E1 and E2, and, for example, may be stored (internally or externally) in a memory assigned to the particular processing unit 110a, 110b or may be provided in the form of a logic structure or of a specialized arithmetic unit or the like.

According to the present invention, it is provided that processing device 100 is designed to invert primary digital input data E1 at least intermittently to obtain secondary digital input data E2. In the specific embodiments shown in FIG. 1, processing device 100 includes for this purpose an inverting unit 120, which may be a discrete inversion logic circuit, for example, which inverts primary input data E1, for example bit by bit, to obtain secondary digital input data E2, as they may be supplied as input data to secondary processing unit 110b.

In a particularly preferred specific embodiment, a hardware structure of secondary processing unit 110b is generally identical to a hardware structure of primary processing unit 100a. For example, the two processing units 110, 110b each form a core of a multi-core processing device 100.

In other specific embodiments, the two processing units may be designed as different functional units of the same processor or the same processing device, e.g., different arithmetic units of a processor. The principle according to the present invention may thus also be applied to processing devices having (only) one core.

In a further preferred specific embodiment, first data processing DV1 is generally identical to second data processing DV2, for example, both data processings DV1, DV2 may use the same algorithm, for example the Advanced Encryption Standard (AES) algorithm or substeps thereof.

According to a further specific embodiment, primary processing unit 110a and secondary processing unit 110b are particularly preferably designed to carry out first data processing DV1 and second data processing DV2 generally simultaneously. Further preferably, primary processing unit 110a and secondary processing unit 110b may be situated on the same semiconductor die (not shown) and/or connected to the same electrical energy supply. In this way, a maximum compensation effect is made possible of physical parameters (electromagnetic radiation, electrical energy consumption) which are detectable due to a side channel attack of the two processing units 110a, 110b.

For example, primary processing unit 110a according to one specific embodiment may be supplied with primary digital input data E1 including, e.g., multiple bits Vᵢ, Vᵢ₊₁, Vᵢ₊₂ . . . for carrying out first data processing DV1 thereon. Inverting unit 120 according to the present invention carries out a bit-by-bit inversion of primary digital input data E1, whereby inverted values v̅ᵢ, v̅ᵢ₊₁, v̅ᵢ₊₂ are obtained, which are supplied to secondary processing unit 110b as secondary digital input data E2 for carrying out second data processing DV2.

If the algorithms underlying data processings DV1, DV2 are carried out, for example, on a mathematical body including two elements, e.g., the Galois field GF(2), digital output data A1, A2 which are obtained by the particular processing units 110a, 110b based on identical data processing DV1, DV2 of the inverse input data E1, E2, as described above, are then the same digital output data A1, A2 if the two processing units 110a, 110b operate without fault. If digital output data A1, A2 which deviate from each other are obtained, this may indicate a fault in the data processing in one of the two processing units 110a, 110b, and may possibly be detected, see below.

If data processing steps DV1, DV2 do not operate on body (Galois field) GF(2), possibly adaptations in the data processing of primary processing unit 110a and/or of secondary processing unit 110b are necessary to achieve comparable or identical results A1, A2 when supplying mutually inverse input data E1, E2.

In one further advantageous specific embodiment, it is provided that processing device 100 is designed to infer an operating state, in particular a fault, of primary processing unit 110a and/or of secondary processing unit 110b as a function of primary digital output data A1 and secondary digital output data A2. This may take place, for example, by an evaluation or by a comparison with the aid of optional comparator unit 130 according to FIG. 1.

In one specific embodiment, comparator unit 130 may then infer a fault if the data A1, A2 supplied to it for comparison are different from each other. The comparison may be carried out bit by bit, for example, or data word by data word having a data word length of n>=1. If the comparison shows that data A1, A2 are identical, comparator unit 130 may conclude that no fault exists on the part of processing units 110a, 110b with respect to calculations DV1, DV2 based on input data E1, E2.

FIG. 2 schematically shows a portion of a further specific embodiment, in which, contrary to the specific embodiment according to FIG. 1, inverting unit 120′ is situated within secondary processing unit 110b, therefore the inverting functionality for obtaining secondary digital input data E2 is integrated into secondary processing unit 110b.

FIG. 3 schematically shows a simplified flow chart of one specific embodiment of the method according to the present invention. In step 200, primary digital input data E1 (see FIG. 1) are at least intermittently inverted to obtain secondary digital input data E2 (FIG. 1). Subsequently, in step 210, first data processing DV1 is carried out in primary processing unit 110a on primary digital input data E1 and, preferably simultaneously thereto, second data processing DV2 is carried out in secondary processing unit 110b on secondary digital input data E2. In this way, a maximum compensation effect is made possible of physical parameters (electromagnetic radiation, electrical energy consumption) which are detectable due to a side channel attack of two processing units 110a, 110b.

In a further advantageous specific embodiment, it is provided that primary processing unit 110a (FIG. 1) and secondary processing unit 110b are designed to carry out at least individual data processing steps of first data processing DV1 and of second data processing DV2 with a non-vanishing time difference with respect to each other. The time difference is particularly preferably randomly or pseudorandomly selected. In this way, the security of the processing device according to the present invention against side channel attacks or fault injection attacks may be increased further.

To generate pseudorandom time differences, according to one specific embodiment, for example, a pseudorandom number generator (not shown) may be provided in processing device 100, which is initializable, for example, with the aid of an initialization sequence that may be specific for the particular processing unit 110a, 110b, for example.

The principle according to the present invention may be particularly advantageously applied to existing multi-core processor architectures, whereby these may be improved with respect to their security against side channel attacks and fault injection attacks. Compared to conventional systems, particularly advantageously almost no additional hardware or software functionality is required, and the principle according to the present invention is also expandable to processing units having more than two cores.

What is claimed is:

1. A processing device, comprising:
a primary processing unit; and
at least one secondary processing unit, the primary processing unit being designed to subject primary digital input data to a predefinable first data processing, whereby primary digital output data are obtained, the secondary processing unit being designed to subject secondary digital input data to a predefinable second data processing, whereby secondary digital output data are obtained;
wherein the processing device is designed to at least intermittently invert the primary digital input data to obtain the secondary digital input data.

2. The processing device as recited in claim 1, wherein the processing device is designed to infer a fault operating state of at least one of the primary processing unit and the secondary processing unit, as a function of the primary digital output data and the secondary digital output data.

3. The processing device as recited in claim 1, wherein an inverting unit is assigned to the secondary processing unit, the inverting unit being designed to form the secondary digital input data as a function of the primary digital input data.

4. The processing device as recited in claim 1, wherein a hardware structure of the secondary processing unit is identical to a hardware structure of the primary processing unit.

5. The processing device as recited in claim 1, wherein the first data processing is identical to the second data processing.

6. The processing device as recited in claim 1, wherein the primary processing unit and the secondary processing unit are designed to carry out the first data processing and the second data processing simultaneously.

7. The processing device as recited in claim 1, wherein the primary processing unit and the secondary processing unit are designed to carry out at least individual data processing steps of the first data processing and of the second data processing with a non-vanishing time difference with respect to each other, the time difference being one of randomly or pseudorandomly selected.

8. The processing device as recited in claim 1, wherein the processing device is designed to carry out at least a portion of a cryptographic procedure, the first and second data processings including at least substeps of at least one cryptographic algorithm.

9. The processing device as recited in claim 1, wherein the primary processing unit and the secondary processing unit are at least one of: i) situated on the same semiconductor die, and ii) connected to the same electrical energy supply.

10. A method for operating a processing device which processing devices includes a primary processing unit and at least one secondary processing unit, method comprising:
subjecting, by the primary processing unit, primary digital input data to a predefinable first data processing to obtain primary digital output data;
subjecting by the secondary processing unit, secondary digital input data to a predefinable second data processing to obtain secondary digital output data; and
inverting at least intermittently, by the processing device, the primary digital input data to obtain the secondary digital input data.

11. The method as recited in claim 10, wherein the primary processing unit and the secondary processing unit, at least intermittently, carry out the first data processing and the second data processing simultaneously.

12. The method as recited in claim 10, wherein the primary processing unit and the secondary processing unit carry out at least individual data processing steps of the first data processing and of the second data processing with a non-vanishing time difference with respect to each other, the time difference being one of randomly or pseudorandomly selected.

13. The method as recited in claim 10, wherein the processing device infers a fault operating state of at least one of the primary processing unit and the secondary processing unit, as a function of the primary digital output data and the secondary digital output data.

14. The method as recited in claim 10, wherein an inverting unit is assigned to the secondary processing unit, the inverting unit forming the secondary digital input data as a function of the primary digital input data.

15. The method as recited in claim 10, wherein the processing device carries out at least a portion of a cryptographic procedure, the first and second data processings including at least substeps of at least one cryptographic algorithm.
